(19) United States
(12) Patent Application Publication
(10) Pub. No.: US 2007/0169412 A1
(43) Pub. Date: Jul. 26, 2007

(54) Sulfur- and alkali-tolerant catalyst

(75) Inventors: Scott A. Sinquefield, Douglasville, GA (US); Taishan Fan, Atlanta, GA (US)

Correspondence Address: Law Offices of Kenneth W. Float, 2095 Hwy. 211 NW, #2F, Braselton, GA, 30517, US

(73) Assignee: Georgia Tech Research Corporation

(21) Appl. No.: 11/698,717

(22) Filed: Jan. 26, 2007

Related U.S. Application Data
(60) Provisional application No. 60/762,235, filed on Jan. 26, 2006.

(51) Int. Cl. B01J 27/043; B01J 27/02; B01J 8/00

(52) U.S. Cl. 48/127.9; 502/216; 502/222

(57) ABSTRACT

Disclosed is an exemplary sulfided cobalt oxide catalyst that may be disposed on an alumina or other catalyst support, for use in destruction of tar compounds formed during gasification of biomass and fossil derived fuels. Most catalysts are rapidly deactivated by sulfur gases and/or alkali metals. Through experimentation, it has been demonstrated that the exemplary catalyst does not suffer deactivation caused by sulfur (as H₂S), or sodium (as Na₂CO₃, Na₂SO₄, or NaCl).

### BACKGROUND

The present invention relates to catalysts for the destruction of tar compounds commonly formed during gasification of both fossil and biomass derived fuels.

The raw product gas from gasification or pyrolysis of fuels such as biomass, coal, black liquor, etc., will typically contain tar compounds. Tars are heavy organic species resulting from the incomplete conversion of the fuel into light hydrocarbon gases or syngas (a mixture of hydrogen and carbon monoxide). Depending on reaction conditions, anywhere from 0.1 to 10% of the organic carbon in the fuel can form these unwanted tar compounds. If the product gas is to be used for high value processes such as gas turbine fuel, or production of synthetic diesel fuel or alcohols, then it must meet strict cleanliness requirements. Tar compounds will cause problems such as fouling processing equipment, poisoning sensitive catalysts, plugging of membranes, etc. Tars also represent lost energy as they otherwise would form additional syngas. Many tar species are known carcinogens. The ability to produce clean syngas from biomass gasification has been identified as a crucial need in the development of a sustainable renewable energy supply for the U.S. Projections are detailed in US Dept of Energy, Office of Biomass Program publications: “Multi Year Program Plan 2007-2012”, and “Biomass as a Feedstock for a Bioenergy and Bioproducts Industry: The Technical Feasibility of a Billion Ton Annual Supply,” for example.

Tars are best destroyed within the process as opposed to using some form of separation to collect them. Catalysts have been used successfully for thermal decomposition of tar compounds utilizing the water vapor present in the product gas. However virtually all known commercially available catalysts are quickly deactivated by either sulfur compounds (usually present as H₂S) and/or alkali (usually sodium) in the fly ash. If the coal or biomass fuel contains sulfur, there will be H₂S present in the syngas if the fuel is pyrolized or gasified. A search for a sulfur and alkali tolerant catalyst was performed under a recent U.S. DOE study; “Stability and Regenerability of Catalysts for the Destruction of Tars from Biomass and Black Liquor Gasification”, project #DE-FC07-001D13875. The project (in which the present inventors collaborated) did identify one catalyst (a sulfided CoMo oxide alloy) which remained active the presence of H₂S and alkali for 300 hours before the activity dropped below a usable level. A process was developed to cyclically regenerate the catalyst for reuse. A more robust catalyst would still be preferred to save the cost of catalyst regeneration.

Related US patents include U.S. Pat. No. 5,954,948 entitled “Hydrocarbon conversion using a sulfur tolerant catalyst,” U.S. Pat. No. 5,888,922 entitled “Sulfur tolerant catalyst,” U.S. Pat. No. 4,370,221 entitled “Catalytic hydrocracking of heavy oils,” U.S. Pat. No. 5,466,427 entitled “Catalysis and treatment of gases with the catalysts,” U.S. Pat. No. 3,966,640 entitled “Supported cobalt sulfate desulfurization catalyst,” and U.S. Pat. No. 6,720,283 entitled “Activated carbon supported cobalt based catalyst for direct conversion of synthesis gas to diesel fuel.” These patents either do not address the presence of sulfur, or are expressly intended for removing sulfur (as opposed to cracking tars), or are not resistant to alkali deactivation, or are of a different formulation than the present invention.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 is a schematic of an exemplary gasifier system including essential components in a syngas clean-up system, of which the cracking of tars is one step;

FIG. 2 is a graph that illustrates the stability of the catalyst during a 1000-hour experiment using benzene as a model tar;

FIG. 3 is a graph that illustrates the stability of the catalyst during a 130-hour experiment using real syngas from steam gasification of black liquor at 400° C.;

FIG. 4 is the infrared spectra of the tar-laden gas stream before and after the catalyst; and

FIG. 5 is a graph that illustrates the stability of the catalyst in the presence of a mix of sodium salts.

### DETAILED DESCRIPTION

Thermal destruction of tars occurs as follows, using benzene as an example tar:

C₆H₆+6H₂O→6CO+9H₂ [rxn1]

C₆H₆+6CO₂→12CO+3H₂. [rxn2]

In gasification systems the objective is to convert the hydrocarbon fuel to H₂ and CO. However, due to moisture in the fuel and thermodynamic considerations, there will always be some H₂O and CO₂ produced. The water-gas shift reaction will govern the distribution in the product syngas:

H₂+CO₂←→H₂O+CO [rxn3]

Thus, there will be some CO₂ and H₂O present to react with the tar compounds. A catalyst will speed rxns 1 and 2. However it must be able to resist poisoning (deactivation of the catalyst active sites) from the impurities in the fuel, such as sulfur gases, alkali metals, etc.

Disclosed is an exemplary sulfided cobalt oxide catalyst that may be disposed on an alumina or other catalyst support, for use in destroying tar compounds formed during gasification of biomass or fossil fuels. Conventional catalysts are rapidly deactivated by sulfur and/or alkali metals, which are present in many biomasses and certain grades of coal. Through laboratory experimentation it has been demonstrated that the exemplary catalyst does not suffer deactivation caused by sulfur (as H₂S or COS), or alkali such as sodium (Na₂CO₃, Na₂SO₄, or NaCl), for example. Furthermore, the exemplary catalyst, if deactivated by coking for example, may be regenerated.

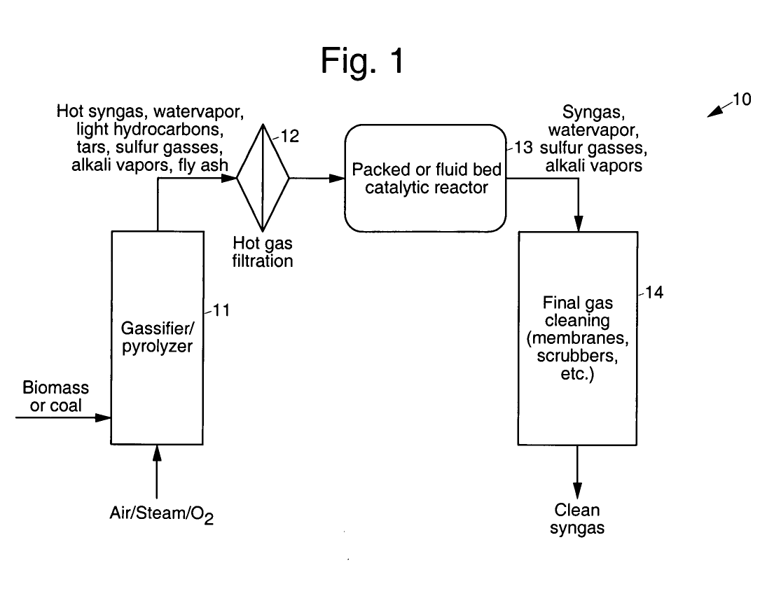

Referring to the drawing figures, FIG. 1 is a schematic of an exemplary gasification system 10 including syngas cleaning process steps. The exemplary gasification system 10 comprises a gassifier/pyrolyzer 11 into which biomass or coal and air, steam or oxygen is passed. Hot syngas, water vapor, light hydrocarbons, tars, sulfur gasses, alkali vapors and fly ash, for example, exit the gassifier/pyrolyzer 11. This mixture of gasses is passed through hot gas filtration apparatus 12. The filtered mixture of gasses is passed through a packed or fluid bed catalytic reactor 13. The packed or fluid bed catalytic reactor 13 contains the presently disclosed sulfided cobalt oxide catalyst. Syngas, water vapor, sulfur gasses and alkali vapors exit the catalytic reactor 13. The syngas, water vapor, sulfur gasses and alkali vapors are input to gas cleaning apparatus 14 containing membranes and scrubbers, and the like. The gas cleaning apparatus 14 outputs clean syngas.

If tars are present and are to be removed catalytically, then this must be done while the gas is still hot (above 600° C.) in order to achieve reasonable reaction rates. Particulates are removed first in the gassifier/pyrolyzer 11, followed by tars in the hot gas filtration apparatus 12, and finally unwanted gases such as H₂S, COS, HCl, NOx, etc. in the catalytic reactor 13 and gas cleaning apparatus 14. The catalyst reactor 13 may be a packed bed or fluidized bed of catalyst support media (such as porous alumina) onto which the catalyst has been deposited.

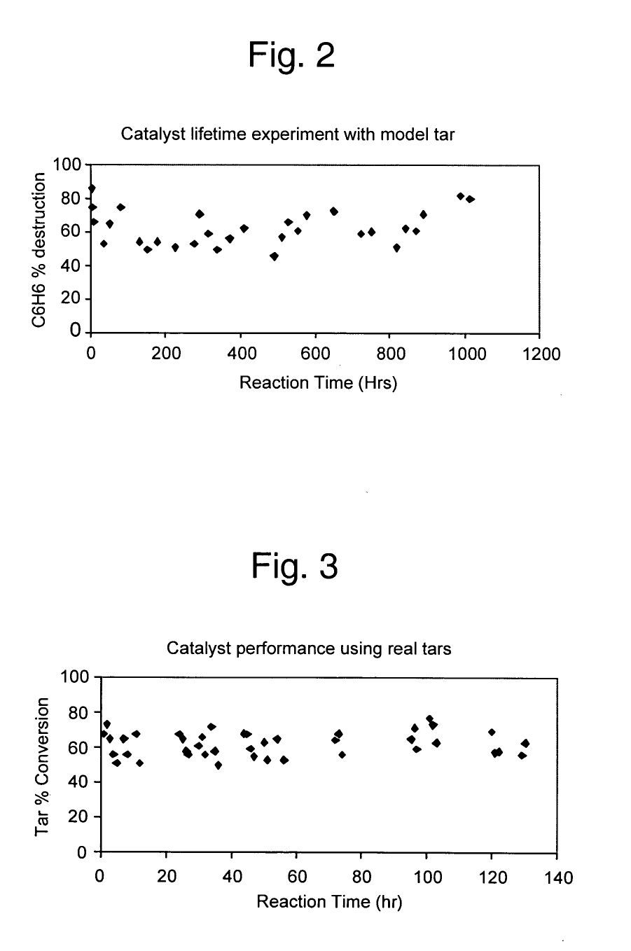

FIG. 2 is a graph that illustrates the stability of the catalyst during a 1000 hour experiment using benzene as a model tar. Benzene is a good model tar since the aromatic ring structure is relatively stable and difficult to break. It is easier to break polyaromatic compounds into mono-ring structures than it is to break a single aromatic ring structure; thus it is the rate limiting step (i.e. if the catalyst can break benzene, it can break other tar species). Benzene is decomposed into CO and CO₂. which is measured and compared to the amount of benzene fed, allowing the conversion to be determined. Relevant conditions were: temperature 700° C., 2300 ppm benzene, 1.2% H₂O vapor, 300-500 ppm H₂S, and 12 liters/(gram catalyst hr) space time. Note that it is possible to achieve complete destruction using more catalyst used and that would be the case for an industrial tar cracker. However it is desirable to see both the increases and decreases in the tar destruction rate or ‘conversion’ throughout the experiment. Since conversion cannot rise above 100%, less catalyst was used in order to achieve a level between 50% and 100% conversion. The desired result is that the conversion remains relatively constant for long periods of time.

FIG. 3 is a graph that illustrates the stability of the catalyst during a 130 hour experiment using a real tar formed by steam reforming (gasification with water vapor) of black liquor at 370° C. This temperature is lower than would be used in an industrial gasifier however more tar is produced at lower temperatures. Since a real fuel was used, there will be a number of compounds present that could potentially poison the catalyst, including H₂S, COS, HCl, and NOx. The black liquor was fed at 150 ml-250 ml/min, and 50% weight solids. The tar concentration leaving the gasifier 11 and fed to the catalytic reactor 13 was about 6800 ppm, which was about three times the concentration of benzene used in the model tar experiments (2300 ppm). The catalyst temperature was 700° C. for this experiment and the space time was 60 l/(g catalyst hr). The tar concentration was calculated using spectra from a Bomem MB-100 Fourier Transform Infrared Spectrometer (using a 4 meter heated gas cell) by comparing the peak areas before and after raw gas passes through the catalyst.

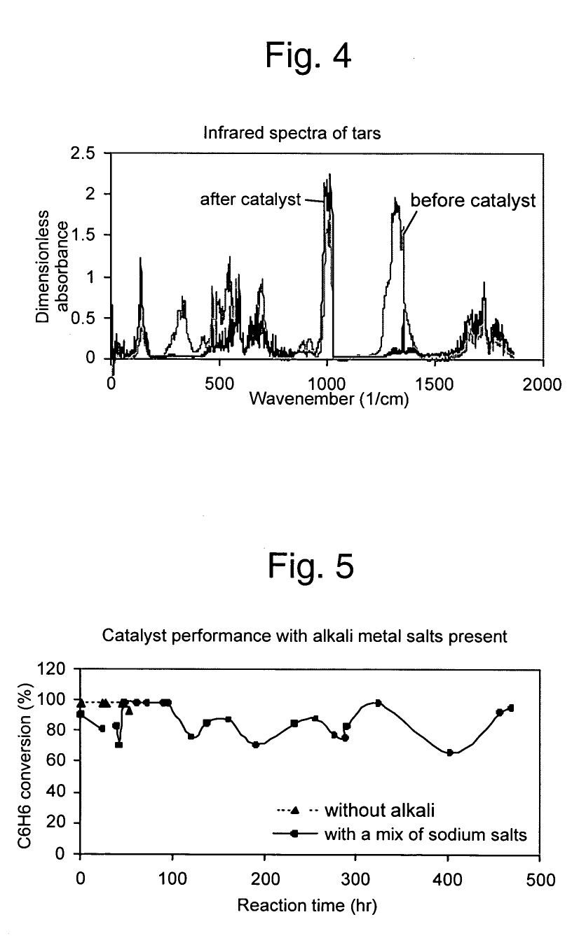

FIG. 4 shows an example of data that forms a single point on FIG. 3. The calculation is based on a peak area in the 2650-3200 cm⁻¹ range of the IR spectrum, which is then compared to a standard peak area in 3000-3150 cm⁻¹ generated by standard gas containing 525 ppm benzene balanced by helium. The IR spectra for the tar compounds has decreased substantially, indicating successful catalytic destruction. Additionally the catalyst showed no loss of activity over the duration of the experiment.

FIG. 5 shows the effects of alkali metal compounds on catalyst stability. An experiment was conducted under the same condition as that shown in FIG. 2 except the catalyst was mixed with alkali metal compounds (NaS 0.1 g, NaCl 0.1 g, Na₂SO₄ 0.1 g and Na₂CO₃ 0.1 g per gram catalyst). The gases were analyzed using a QMS 300 mass spectrum analyzer instead of the Fourier Transform Infrared Spectrometer. The QMS 300 is very sensitive to input gas pressure and the air background in the vacuum chamber, so the data scatter is greater than with the Fourier Transform Infrared Spectrometer. However, careful calibration at the end of the experiment shows the conversion was still high after 480 hours reaction. Thus, there was no impact of alkali salt on catalyst activity.

Exemplary catalysts may be made using the following exemplary processes. In a first exemplary process, a catalyst support is disposed in a sulfided cobalt oxide aqueous solution. Water in the aqueous solution is removed, such as by boiling. The catalyst support is heated to about 450° C. in a fixed or paced bed reactor. Hydrogen sulfide gas is passed through the bed reactor until the catalyst support is saturated. In a second exemplary process, a catalyst support is disposed in a sulfided cobalt oxide aqueous solution. Water in the sulfided cobalt oxide aqueous solution is removed, such as by boiling, to form a cobalt-doped catalyst support. The cobalt-doped catalyst support is disposed in an aqueous solution containing ammonium sulfide. Water and ammonia are removed, such as by boiling, from the aqueous solution containing ammonium sulfide.

It is to be understood that the above-described embodiments are merely illustrative of some of the specific embodiments that represent applications of the principles discussed above. Clearly, numerous and other arrangements can be readily devised by those skilled in the art without departing from the scope of the invention.

What is claimed is:

1. A catalyst comprising sulfided cobalt oxide disposed on a catalyst support.

2. The catalyst recited in claim 1 wherein the catalyst support comprises porous alumina.

3. The catalyst recited in claim 1 which does not deactivate in the presence of sulfur gas or alkali metal.

4. The catalyst recited in claim 3 wherein the alkali metal comprises sodium.

5. The catalyst recited in claim 1 which does not deactivate in the presence of hydrogen sulfide (H₂S).

6. The catalyst recited in claim 1 which does not deactivate in the presence of sodium carbonate (Na₂CO₃).

7. The catalyst recited in claim 1 which does not deactivate in the presence of sodium sulfate (Na₂SO₄).

8. The catalyst recited in claim 1 which does not deactivate in the presence of sodium chloride (NaCl).

9. The catalyst recited in claim 1 which is formed by:
placing the catalyst support in a sulfided cobalt oxide aqueous solution;
removing water from the aqueous solution;
heating the catalyst support to about 450° C. in a fixed or paced bed reactor; and
passing hydrogen sulfide gas through the bed until the catalyst support is saturated.

10. The catalyst recited in claim 9 wherein water in the aqueous solution is removed by boiling.

11. The catalyst recited in claim 1 which is formed by:
placing the catalyst support in a sulfided cobalt oxide aqueous solution;
removing water from the sulfided cobalt oxide aqueous solution to form a cobalt-doped catalyst support;
disposing the cobalt-doped catalyst support in an aqueous solution containing ammonium sulfide; and
removing water and ammonia from the aqueous solution containing ammonium sulfide.

12. The catalyst recited in claim 11 wherein water in the sulfided cobalt oxide aqueous solution is removed by boiling and water and ammonia from the aqueous solution containing ammonium sulfide.

13. A catalyzing system comprising:
a gassifier/pyrolyzer for receiving biomass or coal and air, steam and oxygen and for outputting a gaseous mixture containing hot syngas, water vapor, hydrocarbons, tars, sulfur gasses, alkali vapors and fly ash;
hot gas filtration apparatus for filtering the hot syngas, water vapor, hydrocarbons, tars, sulfur gasses, alkali vapors and fly ash to remove particulates from the gaseous mixture;
a catalytic reactor containing a sulfided cobalt oxide catalyst for decomposing tars from the gaseous mixture; and
gas cleaning apparatus for processing the gaseous mixture to output clean syngas.

14. The catalyzing system recited in claim 13 wherein the sulfided cobalt oxide is disposed on a catalyst support.

15. The catalyzing system recited in claim 13 wherein the wherein the catalyst support comprises porous alumina.

16. The catalyzing system recited in claim 13 wherein the catalyst does not deactivate in the presence of sulfur gas or alkali metal.

17. The catalyzing system recited in claim 12 wherein the catalyst does not deactivate in the presence of hydrogen sulfide (H₂S), sodium carbonate (Na₂CO₃), sodium sulfate (Na₂SO₄), or sodium chloride (NaCl).

18. A catalyst which is formed by:
placing a catalyst support in a sulfided cobalt oxide aqueous solution;
removing water from the aqueous solution to form a cobalt-doped catalyst support;
processing the cobalt-doped catalyst support to form a cobalt-doped catalyst support.

19. The catalyzing system recited in claim 18 wherein the processing comprises:
heating the cobalt-doped catalyst support to about 450° C. in a fixed or paced bed reactor; and
passing hydrogen sulfide gas through the bed until the catalyst support is saturated.

20. The catalyzing system recited in claim 18 wherein the processing comprises:
disposing the cobalt-doped catalyst support in an aqueous solution containing ammonium sulfide; and
removing water and ammonia from the aqueous solution containing ammonium sulfide.
